(19) United States
(12) Patent Application Publication
(10) Pub. No.: US 2010/0332328 A1
(43) Pub. Date: Dec. 30, 2010

(54) Browser Cache Based Ad Insertion

(76) Inventors: Srinivasa DHARMAJI, Cupertino, CA (US); Pavel S. Veselov, Santa Clara, CA (US)

Correspondence Address: GLENN PATENT GROUP, 3475 EDISON WAY, SUITE L, MENLO PARK, CA, 94025, US

(21) Appl. No.: 12/827,310

(22) Filed: Jun. 30, 2010

Related U.S. Application Data
(63) Continuation-in-part of application No. 12/582,573, filed on Oct. 20, 2009.
(60) Provisional application No. 61/197,749, filed on Oct. 29, 2008.

(51) Int. Cl. G06Q 30/00

(52) U.S. Cl. 705/14.64

(57) ABSTRACT

HTML-5 functionality is used to enable browser cache-based ad insertion for display on a mobile handheld device (MHD), thus enabling proper display of ads during user browsing with an MHD.

### CROSS REFERENCE TO RELATED APPLICATIONS

This application is a continuation-in-part of U.S. patent application Ser. No. 12/582,573, filed Oct. 20, 2009 which, in turn, claims priority to U.S. provisional patent application Ser. No. 61/197,749, filed Oct. 29, 2008, each of which is incorporated herein in its entirety by this reference thereto.

### BACKGROUND OF THE INVENTION

1. Technical Field

The invention relates to efficient rendering and display of ads on different mobile handheld devices (MHDs) during browsing. More specifically, the invention relates using the capabilities of the emerging HTML-5 standard in connection with ad insertion during user browsing with an MHD.

2. Description of the Background Art

Advertising to mobile handheld devices (MHDs) is a way to reach people directly, even if they are on the move, because agencies and marketers are now able to connect to such devices. Mobile phones and personal digital assistants (PDAs) are examples of MHDs, which makes such devices a precisely targeted communication channel. Thus, the mobile channel can now deliver excellent campaign effectiveness and response levels when compared to that of other media.

There are multiple channels available to reach the mobile consumer, such as mobile web sites, mobile applications, mobile messaging, and mobile video. Targeted ad insertion and presentation during mobile web browsing has been a problem in the past. This is due to the fact that the pages in mobile browsing are stateless and, hence, any ad that is downloaded and displayed is lost when the user moves to another page. Thus, the only ads that can be displayed on MHDs are those ads that are embedded into the page and that are not separate ad units (ADUs). Separate ADUs can be made specific to the targeted users of ads, where the ads are pre-stored on the MHD based on known user preferences, and where the ads are available for selection from, insertion, rendering, and display by the MHD.

The types of mobile ads range from simple text links to interactive software programs. These ADUs are electronic advertisements that can be viewed using a computer display or other display device in communication with a processor or network. ADUs can include, but are not limited to, banner ads, floating ads, expanding ads, pop-ups, pop-unders, alternate multimedia content, and video clips. A complete ad may comprise many ad units that are combined to deliver a message.

The MHDs of today, including mobile phones with displays, are becoming increasingly sophisticated and include, for example, high resolution screens, sophisticated mobile web browsers, and high-speed access. All of these features allow high-quality and media-rich ADUs to be selected effectively from an external storage and displayed as part of an ad campaign during browsing if a suitable method and system for the ad unit display can be found. It would therefore be advantageous if a system and method were available for inserting targeted ads into browser pages on available displays on MHDs during browsing of the Internet with the MHD by a user.

### SUMMARY OF THE INVENTION

Mobile phones and personal digital assistants (PDAs) having sophisticated display capabilities enable targeted advertisements to be delivered directly to specific users. In the past, browser based targeted advertisement insertion was not practical on mobile handheld display devices (MHDs) unless all of the ads were pre-stored on the MHD because the browsers in such MHDs are stateless. Thus, any ad that is downloaded or inserted into such device is deleted when the browser viewing page is changed. This resulted in partial or incomplete display of ads. The recent HTML-5 browser specification (see http://dev.w3.org/html5/spec/Overview.html) includes a set of application caches which are provided for offline browsing of pages that are downloaded. Further, the HTML-5 browser specification supports Java script and thus allows scripts and any related overlays to run on a browser. A presently preferred embodiment of the invention provides a system and method that uses the capabilities of HTML-5, unexpectedly, to enable browser cache based ad insertion, such that ads are now properly displayed during user browsing with an MHD.

### BRIEF DESCRIPTION OF THE DRAWINGS

FIG. 1 is a block diagram showing a system for browser based ad insertion according to a presently preferred embodiment of the invention;

FIG. 2 is a flowchart showing a set up procedure for browser based ad insertion according to the presently preferred embodiment of the invention; and

FIG. 3 is a flowchart showing browser based ad insertion according to the presently preferred embodiment of the invention.

### DETAILED DESCRIPTION OF THE INVENTION

Mobile phones and personal digital assistants (PDAs) having sophisticated display capabilities enable targeted advertisements to be delivered directly to specific users. In the past, browser based targeted advertisement insertion was not practical on mobile handheld display devices (MHDs) unless all of the ads were pre-stored on the MHD because the browsers in such MHDs are stateless. Thus, any ad that is downloaded or inserted into such device is deleted when the browser viewing page is changed. This resulted in partial or incomplete display of ads. The recent HTML-5 browser specification (see http://dev.w3.org/html5/spec/Overview.html, which is incorporated herein in its entirety by this reference thereto) includes a set of application caches which are provided for offline browsing of pages that are downloaded. Further, the HTML-5 browser specification supports Java script and thus allows scripts and any related overlays to run on a browser. A presently preferred embodiment of the invention provides a system and method that uses the capabilities of HTML-5, unexpectedly, to enable browser cache based ad insertion, such that ads are now properly displayed during user browsing with an MHD.

The invention uses various functions of the HTML-5 web browser standard that are intended for other purposes. Surprisingly, the inventors have discovered that features of the HTML-5 standard can be used in conjunction with a targeted advertising application to enable targeted ad insertion and ad display on an MHD. The presently preferred embodiment of the invention, in addition to the targeted advertising platform, uses functions of the HTML-5 standard that include an application cache for storing web pages that are downloaded for off-line browsing on the MHD and the capability of running executable Java scripts on the browser for display control.

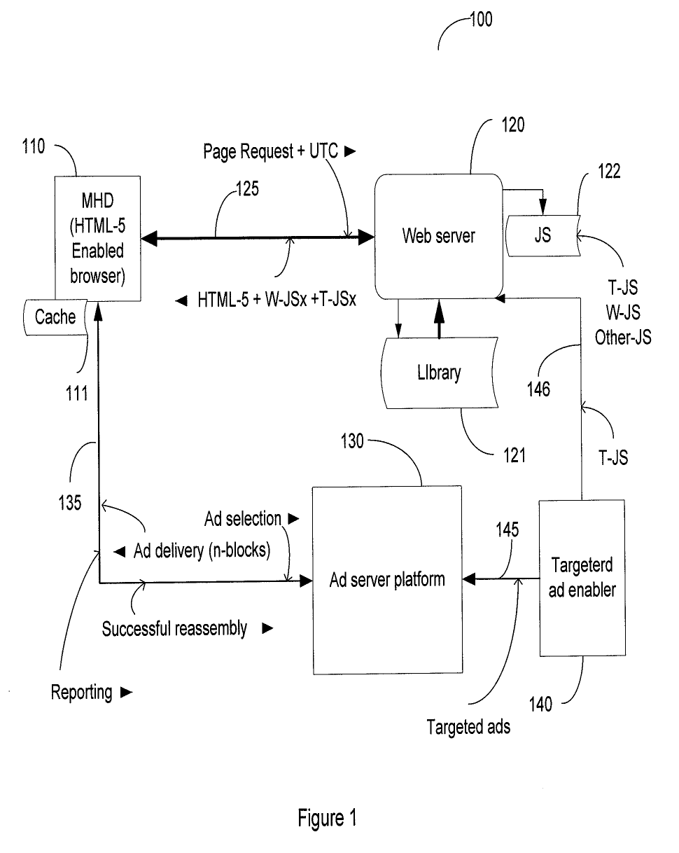

FIG. 1 is a block diagram showing a system for browser based ad insertion according to a presently preferred embodiment of the invention. In FIG. 1, an implementation 100 of the preferred embodiment includes an MHD 110 that uses HTML-5. HTML-5 includes an application cache 111 and also is able to run Java script via the browser.

A targeted ad enabler 140 enters into a negotiated operating agreement with an ad server platform 130 and provides the targeted ads or targeted ad generation capability as an input 145 to the ad server platform 130. Typically, the targeted ads are split into smaller blocks and stored in memory on the ad server platform 130. The targeted ad enabler 140 also enters into a second negotiated operating agreement with a Web server 120 and provides, as input 146 to the Web server 120, at least one executable Java script T-JS relating to the targeted ads. The at least one executable Java script T-JS is stored with other executable Java scripts W-JS that belong to the Web server 120, and any other relevant Java scripts, in a Java script store (JS) 122.

During user browsing with an MHD, a browser Web page request having user target characteristics (UTC) is sent to the Web server 120 by the MHD 110 over a communication link 125. The Web server selects the requested HTML-5 compatible Web pages from its library. The Web server 120 then associates the selected Web pages with selected executable Java scripts. Based on the UTC and page requested, the executable Java scripts include W-JSx for display control of the Web pages and T-JSx, which are the Java scripts that relate to the targeted ad to be displayed on the MHD. This combination is sent back over a communication link 125 to the MHD 110. The MHD 110 receives the HTML-5 page and the Java scripts. It executes the Java scripts on the browser. The Java script W-JSx provides the instructions for the page display, including the instructions for the embedded ads on the requested page. The Java script T-JSx, enables the identification of the targeted ads to be displayed on the browser and provides instructions for rendering, insertion, and display of the identified targeted ads. The MHD 110 then sends an ad selection request to the ad server platform 130 via the communication link 135. The ad server platform 130 selects the targeted ads to be displayed and sends the ads to the MHD 110 via the communication link 135. The selected targeted ads are sent over the communication link 135 in chunks or in blocks, based on the available bandwidth. These blocks are received and stored in one of the memory segments of the application cache 111. The blocks are now reassembled by the MHD and stored in another memory segment of the application cache 111. A message indicating successful reassembly is sent to the ad server platform 130 over the communication link 135. Once reassembled, the selected ads are inserted and displayed via the MHD browser from the application cache 111. The temporary storage of selected targeted ads in the application cache 111 of the MHD 110 enables complete display of targeted ads, even when the browser pages are changed, because the targeted ad continues to render and display from the application cache 111. This use of memory segments of the application cache 111 also enables individual ad units of a targeted ad having multiple ad units to start insertion, rendering, and display as soon as the reassembly of the individual ad unit blocks are completed, without waiting, for the total targeted ad to be reassembled. This allows optimization of the available time for viewer engagement and interaction.

Thus the presently preferred embodiment of the invention allows selection and retrieval of ads, targeted to the user of the MHD and the viewed pages, to be inserted, rendered, and displayed at the time of browsing. This enables user interactions and responses to be collected. For example, user response to the display of a targeted ad is sent back over communication link 135 to the ad server platform 130 for further action.

### Set Up for the Operation

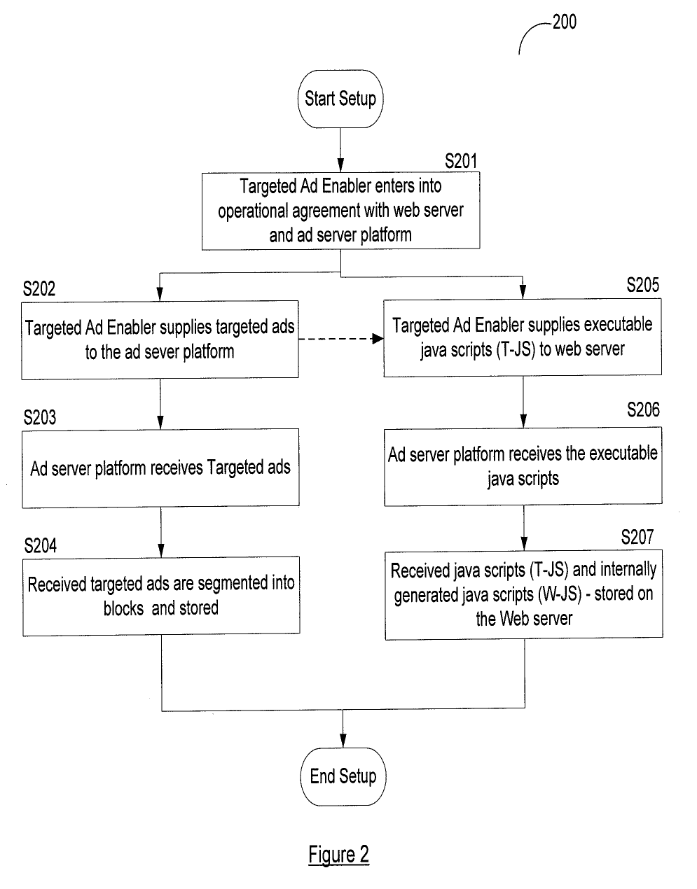

FIG. 2 is a flowchart 200 showing a set up procedure for browser based ad insertion according to the presently preferred embodiment of the invention. Before the system itself is in a state to be active, the targeted ad enabler 140 enters into a negotiated operational agreement and establishes communication with the Web server 120 and an ad server platform 130 (S201).

The targeted ad enabler 140 generates targeted ads and supplies them to the ad server platform 120 (S202).

These targeted ads, each typically containing multiple ad units, are received by the ad server platform 130 (S203).

The ads, received by the ad serving platform 130 are segmented into component ad units, and each ad unit is then segmented into blocks that are suitable for transmission and storage on the ad server platform 130 (S204).

The targeted ad enabler 140 also generates executable Java scripts (T-JS) that are executable on a HTML-5 enabled Web browser located on an MHD. Such Java scripts relate to the targeted ads provided to the ad server platform 130 (S205)

The targeted ad enabler supplies these generated executable Java scripts (T-JS) to the Web server 120 (S206)

The Web server 120 stores the received executable Java scripts with other executable Java scripts, in the Java store 122 of the Web server 120 (S207).

### Browser Based Ad Insertion Operation

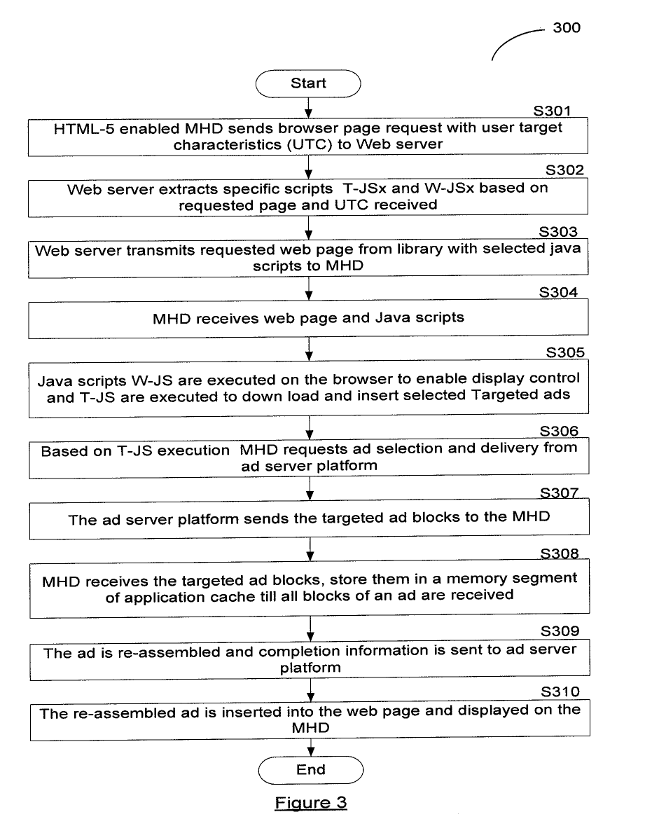

FIG. 3 is a flowchart 300 showing browser based ad insertion according to the presently preferred embodiment of the invention. When a user of an MHD 110 on which HTML-5 is installed initiates browsing activity, a page request with information that includes user target characteristics (UTC) is sent to the Web server 120 (S301).

The Web server extracts the requested browser page from the database library and also ads selected Java scripts W-JSx and T-JSx, based on the UTC and requested Web page. The Java script W-JS is used by the Web server to control the browser page; the Java script T-JSx is used for implementation of the targeted ads (S302).

The requested web page, and the selected Java scripts, are transmitted to the MHD 110 (S303) by the Web server 120.

The MHD 110 receives the Web page and the Java scripts sent by the Web server 120 (S304).

The Java scripts are executed on the MHD 110 having an HTML-5 browser installed thereon. The Java script W-JSx allows the browser to control the insertion and display of the Web page on the MHD 110. The Java script T-JSx, when executed, provides the MHD 110 with instructions to download, insert, and display specific targeted ads on the MHD 110 (S305).

Based on the instructions provided by execution of the Java script T-JS on the browser, the MHD 110 requests selection and delivery of targeted ads from the ad server platform 130 (S306).

The ad server platform 130, on receipt of the targeted ad request from the MHD 110, sends the selected targeted ads to the MHD 110. Because the targeted ads are stored as ad units in the form of blocks, the ad blocks are sent to the MHD 110 (S307).

The MHD 110 receives the targeted ad blocks and uses a segment of the application cache memory 111 to store the received targeted ad blocks until all of the blocks of the targeted ad are received (S308).

Once all of the blocks are received by the MHD 110 and stored in the application cache memory 111, the ad is reassembled and a receipt and reassembly confirmation is sent to the ad server platform 130 (S309).

The reassembled targeted ad is now inserted and displayed on the Web page being displayed on the MHD 110 (S310).

Even though an HTML-5 browser having caching capability and the ability to run Java scripts via the MHD browser is shown herein as an example of the implementation of a preferred embodiment of the invention, those skilled in the art will appreciate that it is possible for the invention to be implemented with any browser having similar caching capability and ability to run other types of scripts with the pages rendered by the browser.

As described above, partial ads may be inserted when blocks of specific ad units of an ad having multiple ADUs are received and reassembled, without the whole of the ad being completely reassembled. In such a case, the reassembled ADUs are displayed in the order that they are received and reassembled to maximize the viewer interaction time for the targeted ad. Any user responses to the ads are sent back to the ad server platform for action.]

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for targeted advertising on a mobile handheld display device (MHD), comprising:
a Web server connected by a first communication link to said MHD;
an ad server platform connected by a second communication link to said MHD;
a targeted ad enabler configured to establish negotiated operational agreements and communication with said ad server platform and said Web server;
wherein said targeted ad enabler is configured to supply targeted ads to said ad server platform for storage thereon;
wherein said targeted ad enabler is configured to supply one or more browser executable scripts for storage on said Web server, wherein said scripts are configured to facilitate selection, insertion, and display control of each of said targeted ads stored on said ad server platform;
wherein said MHD comprises a Web browser configured and operable to render and display a Web page and to execute scripts associated with said Web page, said Web browser comprising an application cache;
wherein said MHD is configured and operable to request and receive Web pages, along with associated executable scripts for said Web pages from said Web server, for selection, insertion, and display control of targeted ads for display in connection with display of said received Web pages on said MHD;
wherein said MHD is configured and operable to execute received scripts on said Web browser;
wherein said MHD is configured and operable to request and receive selected targeted ads from said targeted ad server platform, based on selection information extracted from said scripts;
wherein said MHD is configured and operable to store said received targeted ads in said application cache; and
wherein said MHD is configured and operable to retrieve said targeted ads from said application cache and to insert said targeted ads for rendering by said Web browser for display on said MHD based upon insertion and display control information extracted from said script.

2. The apparatus of claim 1, wherein said targeted ads supplied by said targeted ad enabler are segmented into blocks and stored on said ad server.

3. The apparatus of claim 1, wherein said executable scripts supplied by said targeted ad enabler are stored on said Web server.

4. The apparatus of claim 1, wherein said selected targeted ads are sent in response to a request from said MHD as blocks based on available bandwidth of a connection link,

5. The apparatus of claim 3, wherein said blocks of said selected targeted ads received by said MHD are stored in said application cache for reassembly after completion of reception of all said blocks of each said targeted ad.

6. The apparatus of claim 4, wherein a completion response is sent to said ad server platform on completion of correct reassembly of said ad blocks of said targeted ad.

7. The apparatus of claim 1, wherein said targeted ad comprises a multiplicity of ad units.

8. The apparatus of claim 6, wherein said insertion and display of said targeted ad from said application cache commences when any one of said multiplicity of ad units of said targeted ad has been correctly received and stored in said application cache, based on insertion and display control information extracted from said script.

9. The apparatus of claim 6, wherein said insertion and display of said targeted ad from said application cache commences when said received said blocks of any one of said multiplicity of ad units is correctly reassembled and stored in said application cache, based on a insertion and display control information extracted from said script.

10. The apparatus of claim 1, wherein said Web browser is configured as a HTML-5 browser.

11. A method for inserting and displaying targeted ads on a mobile handheld display device (MHD), comprising the steps of:
negotiating a first operating agreement between a targeted ad enabler and an ad server;
supplying targeted ads from said targeted ad enabler to said ad server and storing said targeted ads on said ad server;
negotiating a second operating agreement between said targeted ad enabler and a Web server;
storing executable scripts on said Web server, said executable scripts facilitating selection, insertion, and control of each of said targeted ads;
generating a request for a Web page with a Web browser embedded in said MHD;
said MHD sending said request to said Web server along with user preference information;
said Web server sending said requested Web page to said MHD along with selected executable scripts, wherein said executable scripts are selected from said stored said executable scripts based upon said requested Web page and said user preference information;
said MHD receiving said requested Web page and said executable scripts and executing scripts to select a targeted ad;
said Web browser on said MHD generating a request for said selected targeted ad;
said MHD sending said generated request to said ad server;
said ad server responding to said request by sending said selected targeted ad to said MHD;
said MHD receiving said selected targeted ad and storing said selected targeted ad in an application cache associated with said Web browser;
said MHD inserting, rendering, and displaying said stored selected targeted ad into a Web page displayed on said MHD.

12. The method of claim 11, further comprising the steps of:
segmenting said targeted ads stored on said ad server into blocks; and
storing said blocks on said ad server.

13. The method of claim 12, wherein said stored targeted ad comprises multiple ad units, wherein each said ad unit is segmented into blocks, and wherein said blocks are stored on said ad server.

14. The method of claim 11, further comprising the step of:
said ad server sending said selected targeted ad to said MHD as blocks, depending on an available bandwidth.

15. The method of claim 14, further comprising the steps of:
receiving at said MHD; and
storing said ad blocks in said application cache for reassembly.

16. The method of claim 15, further comprising the step of:
sending a reassembly completion notice to said ad server upon successful reassembly of said selected targeted ad.

17. The method of claim 11, further comprising the step of:
said ad server generating said targeted ads stored on said ad server.

18. A method for inserting ads into a Web page that is displayed on a mobile handheld display device (MHD), comprising the step of:
using an HTML-5 enabled browser embedded in said MHD to run a Java script that controls selection, insertion, and display of targeted ads from an ad source on an MHD display.

19. A method for inserting ads into a Web page that is displayed on a mobile handheld display device (MHD), comprising the step of:
performing browser cache based insertion and display of targeted ads by accepting ad blocks, storing said ad blocks, reassembling said ad blocks, and displaying said ad blocks from an application cache associated with an HTML-5 enabled browser embedded in said MHD.

20. The method of claim 19, further comprising the steps of:
using available memory cache segments to collect said ad blocks;
reassembling said ad blocks; and
inserting and displaying a completed ad on a Web page displayed on said MHD with said browser.

21. The method of claim 19, further comprising the step of:
inserting and displaying re-assembled ad units of a multi-ad unit ahead of complete receipt of all ad units of an ad.
